(19) United States
(12) Patent Application Publication
(10) Pub. No.: US 2007/0246863 A1
(43) Pub. Date: Oct. 25, 2007

(54) Nano far-infrared health pad fabrication method

(75) Inventor: Chun-Yu Chin, Taipei Hsien (TW)

Correspondence Address: TROXELL LAW OFFICE PLLC, SUITE 1404, 5205 LEESBURG PIKE, FALLSCHURCH, VA, 22041, US

(73) Assignee: Shyang-Wei Chen

(21) Appl. No.: 11/410,189

(22) Filed: Apr. 25, 2006

(51) Int. Cl. C08J 5/00

(52) U.S. Cl. 264/331.11

(57) ABSTRACT

A nano far-infrared health pad fabrication method for making a nano far-infrared health pad by: mixing 15-25 wt % nano far-infrared powder with 75-85 wt % liquid silicon rubber into a nano far-infrared compound and then using a mold to cast the nano far-infrared compound into the desired shape of nano far-infrared health pad.

### BACKGROUND OF THE INVENTION

1. Field of the Invention

The present invention relates to a nano far-infrared health pad fabrication method for making nano far-infrared health pads that can be used for making an insole for shoe, a chest pad, or a lining for safety helmet, glove or a pad for the back and spine or bedding.

2. Description of the Related Art

Far-infrared is a light wave in sun light, having a wavelength within about 4 μm˜1000 μm that provides beneficial effects to organisms. Therefore, far-infrared is called “the light of birth” in nature. It is reported that far-infrared powder at wavelength (emission rate) 7 μm˜15 μm can help expand blood vessels, improving blood circulation and metabolism. Far-infrared powder can also be used to preserve foods, remove bad smell and moisture.

Taiwan Patent Publication No. 362981 discloses a far-infrared health pad fabrication method. This far-infrared health pad fabrication method comprises the steps of material mixing where far-infrared powder is mixed with silicon rubber to form a powder mixture, high-pressure grinding where the powder mixture is continuously ground, roller-pressing where the powder mixture is roller-pressed into a sheet member, and hot-molding where the sheet member is molded into the desired shape. During the aforesaid mixing procedure, far-infrared powder is added to silicon rubber several times with a small quantity per each addition, and at the same time a hardening agent and a vulcanizer are added to the powder mixture. This far-infrared health pad fabrication method requires numerous, specialized fabrication equipment, and this method is complicated and not suitable for mass production. Furthermore, the required labor and time consuming nature of this far-infrared health pad fabrication method greatly increases the manufacturing cost.

### SUMMARY OF THE INVENTION

The present invention has been accomplished under the circumstances in view. It is therefore the main object of the present invention to provide a nano far-infrared health pad fabrication method, which is practical for mass production to lower the manufacturing cost. To achieve this and other objects of the present invention, the nano far-infrared health pad fabrication method comprises the steps of (a) mixing 15-25 wt % nano far-infrared powder with 75-85 wt % liquid silicon rubber into a far-infrared compound, (b) using a hot mold to cast the nano far-infrared compound into the desired shape of nano far-infrared health pad.

### BRIEF DESCRIPTION OF THE DRAWING

FIG. 1 is a nano far-infrared health pad manufacturing flow chart according to the present invention.

### DETAILED DESCRIPTION OF THE INVENTION

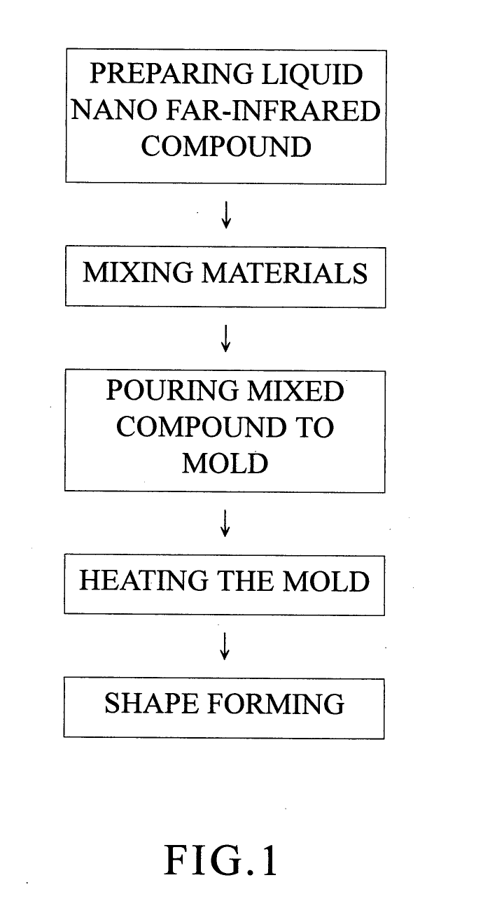

Referring to FIG. 1, a nano far-infrared health pad in accordance with the present invention is a health pad suitable for use in shoes, chest pads, or safety helmets, gloves and bedding. The fabrication method of the nano far-infrared health pad includes the steps of:
(A) preparing a nano far-infrared powder containing at least SiO2, Al2O3, Cao and then mixing 15-25 wt % prepared nano far-infrared powder with 75-85 wt % liquid silicon rubber to form a liquid nano far-infrared compound;
(B) preparing a mold having a cavity designed subject to a predetermined shape for casting, and then filling the prepared liquid nano far-infrared compound into the cavity of the mold, and then covering a predetermined shape of elastic cotton cloth, and then closing the mold;
(C) heating the mold to about 120° C.˜130° C. for a predetermined length of time to harden the liquid nano far-infrared compound into a finished product (nano far-infrared health pad); and
(D) cooling the mold and then removing the finished product from the mold for further application.

As indicated above, the nano far-infrared power is evenly mixed with the liquid silicon rubber, therefore the nano far-infrared power is evenly distributed in the finished product (nano far-infrared health pad). Further, because the nano far-infrared health pad is made by directly casting the prepared liquid nano far-infrared compound into the desired shape, the fabrication of the nano far-infrared health pad is simple and efficient, thereby lowering the manufacturing cost.

The average emission rate of the nano far-infrared health pad at wavelength 3 μm˜15 μm is 0.819, and the average emission rate of the nano far-infrared powder at wavelength 3 μm˜15 μm is 0.85.

The nano far-infrared health pad according to the present invention can be used for making an insole for shoe, a chest pad, or a lining for safety helmet, glove or bedding. The nano far-infrared health pad of the present invention can also be used to make packing boxes or the like for preserving foods or removing bad odors and moisture. The nano far-infrared energy released from the nano far-infrared health pad according to the present invention can stimulate the circulation of blood, improving the functioning of metabolism.

Further, Silicone Pressure Sensitive Adhesive may be used to substitute for the liquid silicon rubber used in Step (A) so that the finished product (nano far-infrared health pad) obtained after Step (D) has one side with a sticky adhesive. The adhesive side of the finished product can be covered with a Polyurethane film or strippable paper before use. After removing the Polyurethane film or strippable paper, the nano far-infrared health pad can be adhered to any desired part of the user's body.

Additionally, Liquid States Acrylic Resins may be used to substitute for the liquid silicon rubber used in Step (A) so that the finished product (nano far-infrared health pad) obtained after Step (D) has one sticky side. This sticky side of the finished product can be covered with a Polyurethane film or strippable paper before use. After removal of the Polyurethane film or strippable paper, the nano far-infrared health pad can be adhered to any desired part of the user's body. The Liquid States Acrylic Resins may be diluted with a small amount of Toluene or Ethyl Acetate before use.

Further, during Step (A), nano far-infrared powder can be mixed with minute quantity photo catalyst and minute quantity minus ion powder to substitute for the 15-25 wt % prepared nano far-infrared powder for mixing with 75-85 wt % liquid silicon rubber to form the desired liquid nano far-infrared compound.

Further, during Step (A), nano far-infrared powder can be mixed with minute quantity photo catalyst to substitute for the 15-25 wt % prepared nano far-infrared powder for mixing with 75-85 wt % liquid silicon rubber to form the desired liquid nano far-infrared compound.

Further, during Step (A), nano far-infrared powder can be mixed with minute quantity minus ion powder to substitute for the 15-25 wt % prepared nano far-infrared powder for mixing with 75-85 wt % liquid silicon rubber to form the desired liquid nano far-infrared compound.

What is claimed is:

1. A nano far-infrared health pad fabrication method comprising the steps of:
a) preparing a nano far-infrared based powder containing SiO2, Al2O3, Cao and then mixing 15-25 wt % said nano far-infrared based powder with 75-85 wt % liquid silicon rubber to form a liquid nano far-infrared compound;
b) preparing a mold having a cavity for casting and then filling the prepared liquid nano far-infrared compound into the cavity of said mold for casting;
c) heating said mold at heating temperature 120° C.˜130° C. for a predetermined length of time to harden said liquid nano far-infrared compound into a nano far-infrared health pad; and
d) cooling said mold and then removing said nano far-infrared health pad from said mold.

2. The nano far-infrared health pad fabrication method as claimed in claim 1, wherein said 15-25 wt % nano far-infrared based powder is selected from the combinations including (a) nano far-infrared powder with minute quantity photo catalyst and minute quantity minus ion powder, (b) nano far-infrared powder with minute quantity photo catalyst, (c) nano far-infrared powder with minute quantity minus ion powder.

3. A nano far-infrared health pad fabrication method comprising the steps of:
a) preparing a nano far-infrared based powder containing SiO2, Al2O3, Cao and then mixing 15-25 wt % said nano far-infrared based powder with 75-85 wt % Silicone Pressure Sensitive Adhesive to form a liquid nano far-infrared compound;
b) preparing a mold having a cavity for casting and then filling the prepared liquid nano far-infrared compound into the cavity of said mold for casting;
c) heating said mold at heating temperature 120° C.˜130° C. for a predetermined length of time to harden said liquid nano far-infrared compound into a nano far-infrared health pad; and
d) cooling said mold and then removing said nano far-infrared health pad from said mold.

4. The nano far-infrared health pad fabrication method as claimed in claim 3, wherein said 15-25 wt % nano far-infrared based powder is selected from the combinations including (a) nano far-infrared powder with minute quantity photo catalyst and minute quantity minus ion powder, (b) nano far-infrared powder with minute quantity photo catalyst, (c) 15 wt % nano far-infrared powder with minute quantity minus ion powder.

5. A nano far-infrared health pad fabrication method comprising the steps of:
a) preparing a nano far-infrared based powder containing SiO2, Al2O3, Cao and then mixing 15-25 wt % said nano far-infrared based powder with 75-85 wt % Liquid States Acrylic Resins to form a liquid nano far-infrared compound;
b) preparing a mold having a cavity for casting and then filling the prepared liquid nano far-infrared compound into the cavity of said mold for casting;
c) heating said mold at heating temperature 120° C.˜130° C. for a predetermined length of time to harden said liquid nano far-infrared compound into a nano far-infrared health pad; and
d) cooling said mold and then removing said nano far-infrared health pad from said mold.

6. The nano far-infrared health pad fabrication method as claimed in claim 5, wherein said 75-85 wt % Liquid States Acrylic Resins is diluted with Toluene and Ethyl Acetate.

7. The nano far-infrared health pad fabrication method as claimed in claim 5, wherein said 15-25 wt % nano far-infrared based powder is selected from the combinations including (a) nano far-infrared powder with minute quantity photo catalyst and minute quantity minus ion powder, (b) nano far-infrared powder with minute quantity photo catalyst, (c) nano far-infrared powder with minute quantity minus ion powder.

8. The nano far-infrared health pad fabrication method as claimed in claim 5, wherein said cavity of said mold is designed subject to a predetermined shape so that the molded nano far-infrared health pad is directly applicable to a human being.
